(19) United States
(12) Patent Application Publication
(10) Pub. No.: US 2025/0354585 A1
(43) Pub. Date: Nov. 20, 2025

(54) BEARING UNIT PROVIDED WITH A SEALING DEVICE

(71) Applicant: Aktiebolaget SKF, Göteborg (SE)

(72) Inventors: Andrea A. BERTOLINI, Carrara (IT); Fausto BARACCA, Massa (IT); Renato BERTI, Massa (IT)

(21) Appl. No.: 19/217,079

(22) Filed: May 23, 2025

(30) Foreign Application Priority Data
May 20, 2024 (IT) 102024000011365

(51) Int. Cl. F16C 33/80

(52) U.S. Cl. CPC F16C 33/80

(57) ABSTRACT

A bearing unit having a central axis of rotation and having a radially outer ring, stationary, a radially inner ring, rotatable, and a sealing device, which is provided with: a first shield integral with the radially outer ring and which supports a first sealing element; a second shield integral with the radially inner ring and which supports a second sealing element; wherein the first and the second sealing element are provided with respective first and second shaped surfaces which: are axially opposed but not in contact with each other; define a plurality of ridges and valleys; and are radially staggered so that each ridge of the first shaped surface corresponds to a valley of the second shaped surface and vice versa.

### CROSS-REFERENCE TO RELATED APPLICATION

This application is based on and claims priority to Italian Patent Application No. 102024000011365, filed on May 20, 2024 in the Italian Patent Office, the entirety of which is hereby incorporated by reference.

### FIELD

The present disclosure relates to a bearing unit provided with a sealing device and for use preferably, but not exclusively, in all industrial applications which may involve quite high stresses.

### BACKGROUND

Known bearing units comprise an outer ring and an inner ring that can rotate relative to one another by virtue of the interposition of a row of rolling bodies, and also have a respective sealing device interposed between the two rings to protect the bearing units against the ingress of external contaminants.

According to the prior art, the sealing device comprises:
a first metal shield anchored by interference in a housing groove formed internally to the outer ring,
a first elastomeric sealing element rigidly secured to the shield by means of a process of vulcanization in such a way as to be in one piece with said shield. The sealing element has at least one radially inner contacting lip, for frictional contact with the inner ring of the bearing unit,
a second metal shield, axially external with respect to the first shield, rigidly secured by interference to the inner ring and, therefore, rotatable relative to the first shield,
a second elastomeric sealing element rigidly secured to the second shield by means of a process of vulcanization in such a way as to be in one piece with said shield and provided with at least one axially internal contacting lip, for frictional contact with the first shield.

Known sealing devices therefore ensure a seal against external contaminants but must also prevent lubricant from leaking out of the bearing unit. The retention of lubricant grease is a very important characteristic of bearing units for industrial applications: sufficient lubrication must be ensured including in environments involving extreme contaminants.

Known sealing devices can ensure good performance if they are provided with several contacting lips. However, solutions of this type result in an increase in friction losses and therefore higher temperatures and dissipated power.

To sum up, the technical problems to be solved are:
sealing against external contaminants so as not to reduce the useful life of bearing units and sealing of the lubricant inside the bearing unit,
friction losses owing to contacting lips.

### SUMMARY

To substantially solve the technical problems set out above, the present disclosure defines a bearing unit provided with a sealing device offering high performance and optimized in terms of shape and geometry.

Therefore, the present disclosure provides a bearing unit provided with a sealing device and having the features set out in the independent claim.

Further embodiments of the disclosure, preferred and/or particularly advantageous, are described according to the features set out in the attached dependent claims.

### BRIEF DESCRIPTION OF DRAWINGS

The attached drawings illustrate a non-limiting embodiment of the disclosure, in which:

FIG. 1 is a view in cross section of a bearing unit provided with a sealing device, according to a preferred embodiment of the present disclosure,

FIG. 2 shows, on a larger scale, the sealing device of FIG. 1, and

FIG. 3 shows a detail, on an even larger scale, of the anchoring portion of the sealing device of FIG. 1.

### DETAILED DESCRIPTION

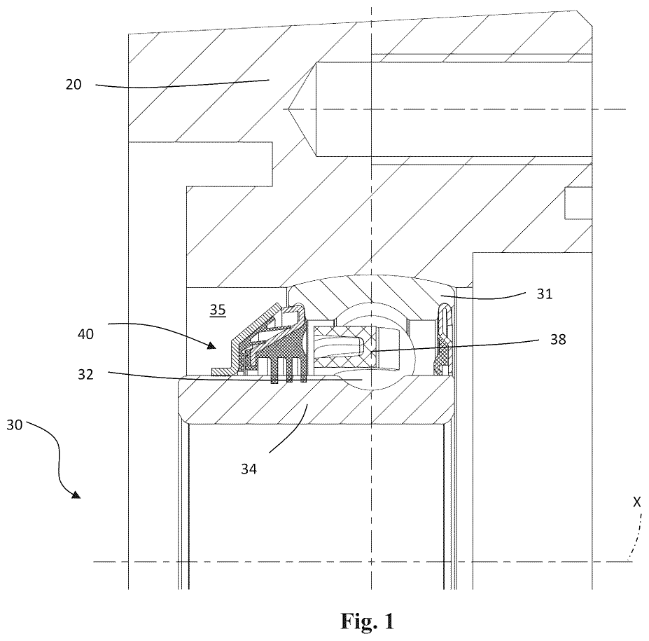

With reference to FIG. 1, the reference sign 30 generally designates a bearing unit having an axis X of rotation, housed inside a casing 20 and comprising:
a radially outer ring 31, provided, internally and towards the axis X, with at least one anchoring groove 31a, annular and shaped,
a radially inner ring 34,
a plurality of rolling bodies 32, in this example balls, interposed between the outer ring 31 and the inner ring 34,
a cage 38 for holding and retaining the rolling bodies 32.

According to the preferred embodiment of the present disclosure described herein, the outer ring 31 is a stationary ring, while the inner ring 34 is a ring rotatable about the axis X.

Throughout the present description and in the claims, terms and expressions indicating positions and orientations, such as “radial” and “axial”, are to be understood with reference to the central axis X of rotation of the bearing unit 30.

Expressions such as “axially external” and “axially internal”, on the other hand, refer to the sealing device when mounted in the bearing unit, and in the case at hand, preferably, refer to a side via which the sealing device is inserted in the housing groove of the radially outer ring and, respectively, a side opposite the side of insertion.

The outer ring 31 and the inner ring 34 define, between them, a cavity 35 which, if not shielded, allows contaminants and impurities to get inside the bearing unit 30.

The bearing unit 30 further comprises a sealing device 40, which is positioned inside the cavity 35 in order to shield and protect said bearing unit 30 against the ingress of contaminants and impurities.

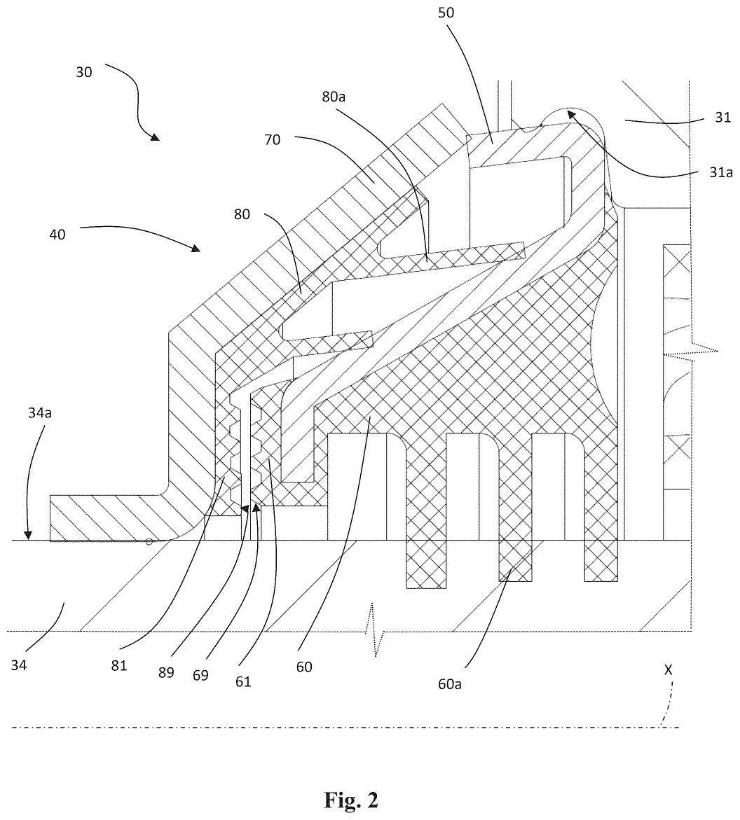

With reference also to FIG. 2, the sealing device 40 comprises:
a first shield 50, annular and shaped, preferably made from sheet metal, with a standard thickness of around 0.5 mm so as to be sufficiently rigid and anchored by interference in the housing groove 31a formed internally to the outer ring 31. The shield 50 is therefore stationary,
a first elastomeric sealing element 60 rigidly secured to the shield 50 by means of a process of vulcanization in such a way as to be in one piece with said shield. The sealing element is provided with at least one radially inner contacting lip 60a, for frictional contact with the inner ring 34 of the bearing unit 30. In the embodiment shown in the figures, there are three lips 60a, axially adjacent and having a substantially radial direction,
a second shield 70, also annular and shaped and preferably made from sheet metal, with a standard thickness of around 0.5 mm so as to be sufficiently rigid. The shield 70 is axially external with respect to the first shield 50 and rigidly secured by interference to a radially outer surface 34a of the inner ring 34. The shield 70 is therefore rotatable,
a second elastomeric sealing element 80 rigidly secured to the second shield 70 by means of a process of vulcanization in such a way as to be in one piece with said shield and provided with at least one axially internal contacting lip 80a, for frictional contact with the first shield 50. In the embodiment shown in the figures, there are two lips 80a, radially adjacent and extending obliquely in the direction away from the axis X of rotation.

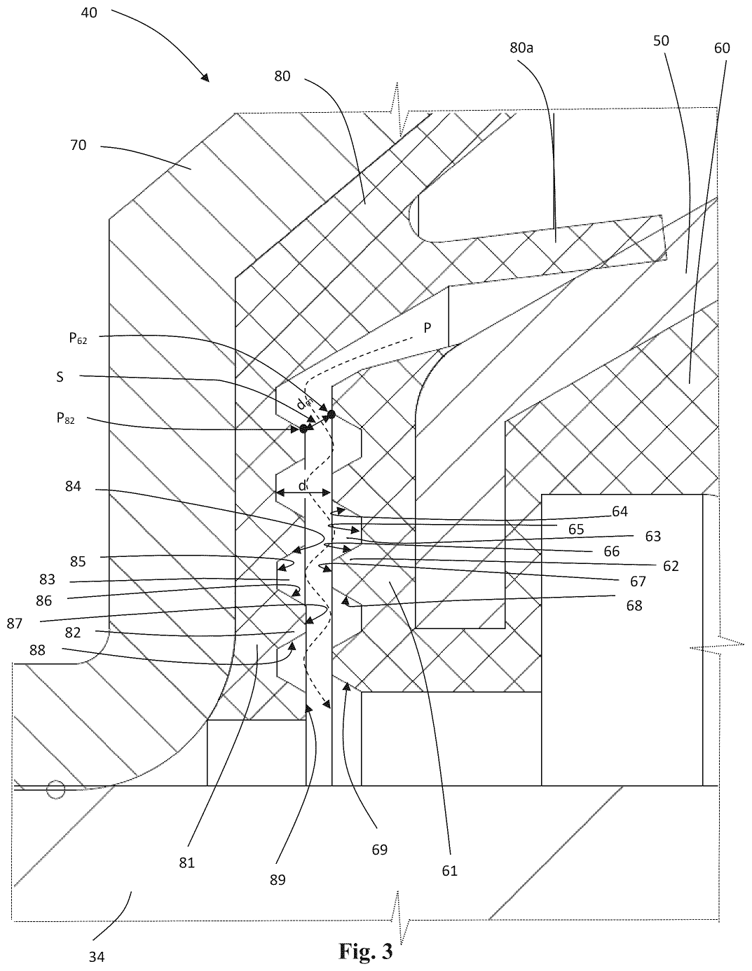

According to the present disclosure and with reference also to FIG. 3, the first sealing element 60 is provided with an annular portion 61, radially internal and axially external, which has a shaped surface 69, axially external. The second sealing element 80 is also provided with an annular portion 81, radially internal and axially internal, which has a shaped surface 89, axially internal. The two portions 61 and 81 are axially opposed.

In particular, the shaped surface 69 of the first portion 61 defines a plurality of annular ridges 62 or protrusions, axially external, radially alternating, and a plurality of annular valleys 63 or grooves. Both the ridges and the valleys are obtained by a 360° rotation of a geometric figure corresponding to an isosceles trapezoid. Each valley 63 is delimited by a pair of oblique surfaces 64, 66 and by a bottom surface 65. Each ridge 62 is delimited by a pair of oblique surfaces 66, 68 and by a top surface 67. A ridge and a valley that are adjacent share an oblique surface 66 of the pair of oblique surfaces.

Likewise, the shaped surface 89 of the second annular portion 81 defines a plurality of annular ridges 82, axially internal, radially alternating, and a plurality of annular valleys 83. Both the ridges and the valleys are obtained by a 360° rotation of a geometric figure corresponding to an isosceles trapezoid. Each valley 83 is delimited by a pair of oblique surfaces 84, 86 and by a bottom surface 85. Each ridge 82 is delimited by a pair of oblique surfaces 86, 88 and by a top surface 87. A ridge and a valley that are adjacent share an oblique surface 86 of the pair of oblique surfaces.

According to the disclosure, the respective first 69 and second 89 shaped surface of the first 61 and second 81 portion are axially opposed and radially staggered in such a way that each ridge 62 of the first shaped surface 69 corresponds to a valley 83 of the second shaped surface 89 and, vice versa, each ridge 82 of the second shaped surface 89 corresponds to a valley 63 of the first shaped surface 69.

The reciprocal position of the shaped surfaces 69 and 89 of the sealing elements 60, 80 defines a contactless seal, or a winding path P, which it is difficult for contaminants to get through.

The axial play of the bearing unit can further enhance this effect, especially under certain favorable conditions. To be specific, the distance d between the top surface 67 of the generic ridge 62 of the first shaped surface 69 and the bottom surface 85 of the corresponding valley 83 of the second shaped surface 89 (or, vice versa, the distance d between the top surface 87 of the generic ridge 82 of the second shaped surface 89 and the bottom surface 65 of the corresponding valley 63 of the first shaped surface 69) may be no more than 0.4 mm when there is maximum axial play and may be as small as 0 mm when there is minimum axial play. The distance d between the top surface 67 of the ridge 62 and the bottom surface 85 of the valley 83 (or, vice versa, between the top surface 87 of the ridge 82 and the bottom surface 65 of the corresponding valley 63) is around 0.2 mm. As stated above, the axial play of the bearing unit may modify this average distance, this axial play depending on the dimensions and tolerances of the components of the bearing unit. However, given the standard applications of bearing units, the variability of the average distance resulting from axial play will be within +0.1/0.2 mm.

The blocking effect of the winding path P is further enhanced by the fact that this path has a plurality of narrow sections S for the passage of contaminants. The narrow sections S have a minimum distance dₘ corresponding to the distance between two edges P₆₂ and P₈₂ of the top surfaces 67, 87 of respective ridges 62, 82, axially opposed and radially staggered, belonging to the corresponding first 69 and second 89 shaped surface. Based on simple geometric considerations, the minimum distance dₘ will be between 50% and 75% of the distance d, between the bottom of a valley and the top of the corresponding ridge.

Lastly, the winding path P, because of the number of changes in direction resulting from the shaped surfaces 69, 89, has a length that is around 2-3 times the length of a purely radial path that would be defined if the facing surfaces 69, 89 were not shaped but purely annular.

The narrow sections S defined above and the continuous changes in direction in the winding path P create a genuine “bottleneck” for contaminants. To be specific, they have the effect of a “barrier” against solid contaminants, which are trapped upstream of the narrow sections, and, like the effect caused by a convergent channel, slowing down liquid contaminants, the path of which is further blocked by the barrier of solid contaminants that are trapped upstream of the narrow sections.

This solution, as well as being applied for the preferred embodiment shown in the figures, may be used in all applications of sealing devices in which there are a fixed shield and a rotatable shield opposite one another, both bearing elastomeric sealing elements.

During the process of assembly, lubricant grease should be inserted between these ridges and valleys. It is sufficient to add it between the ridges of the first sealing element or, alternatively, between the ridges of the second sealing element, before assembling them in the bearing unit. The addition of lubricant grease has two advantages:
it further improves the barrier effect of the winding path against external contaminants,
in the case where, owing to axial play, there is frictional contact between the shaped surfaces 69, 89, the presence of grease will mitigate any friction generated between the contacting surfaces.

The ridges and the valleys may have alternative shapes without thereby departing from the scope of the present disclosure. For example, the top surface 67, 87 of the generic ridge may have a zero length in the radial direction. In this case, the figure generating the ridge would be a triangle, for example isosceles. The same configuration could apply to a valley with the bottom surface 65, 85 having a zero length in the radial direction and with an isosceles triangle as generating figure. This alternative configuration could be implemented:
only on the first sealing element 60,
only on the second sealing element 80,
on both sealing elements.

It is also possible to define a hybrid profile: the second sealing element 80 could have all ridges with a triangular generating figure and all valleys with a trapezoidal generating figure and, conversely, trapezoidal ridges and triangular valleys for the first sealing element 60. Naturally, this hybrid profile could also be produced in the opposite configuration: the first sealing element could have all ridges with a triangular generating figure and all valleys with a trapezoidal generating figure and, conversely, trapezoidal ridges and triangular valleys for the second sealing element 80.

All these alternative configurations which include at least one element (ridge or valley) generated by a triangle instead of a trapezoid would have the advantage of further reducing the minimum distance dₘ characterizing the narrow sections S.

To sum up, the bearing unit provided with the sealing device according to the present disclosure ensures better sealing performance without increasing friction losses thanks to the definition of a contactless seal that generates a winding path for contaminants, this path having numerous changes in direction and a plurality of narrow sections in such a way as to generate a genuine barrier effect to contaminants.

In addition to the embodiment of the disclosure as described above, it is to be understood that there are numerous other variants. It is also to be understood that said embodiments are merely examples and do not limit the scope of the disclosure, its applications, or its possible configurations. On the contrary, although the above description enables those skilled in the art to apply the present disclosure according to at least one example of an embodiment, it is to be understood that numerous variations of the components described are possible, without thereby departing from the scope of the disclosure as defined in the appended claims, interpreted literally and/or according to their legal equivalents.

What is claimed is:

1. A bearing unit having a central axis of rotation and comprising:
a radially outer ring, stationary,
a radially inner ring, rotatable, defining, with the radially outer ring, a cavity, and
a sealing device, which is housed in the cavity and includes, in turn:
a first shield integral with the radially outer ring and which supports a first sealing element,
a second shield integral with the radially inner ring and which supports a second sealing element,
the bearing unit being characterized by the fact that the first and the second sealing element are provided with respective first and second shaped surfaces which:
are axially opposed but not in contact with each other,
define a plurality of ridges and valleys, where on each shaped surface each ridge is radially alternated with a valley, and
are radially staggered so that each ridge of the first shaped surface corresponds to a valley of the second shaped surface and each ridge of the second shaped surface corresponds to a valley of the first shaped surface.

2. The bearing unit according to claim 1, wherein each ridge is delimited by a pair of oblique surfaces and by a top surface.

3. The bearing unit according to claim 1, wherein each valley is bounded by a pair of oblique surfaces and by a bottom surface.

4. The bearing unit according to claim 1, in which a distance between two edges of the top surfaces of respective ridges, axially opposed and radially staggered, belonging to the corresponding first and second shaped surfaces is between 50% and 75% of a distance between the top surface of the ridge and the bottom surface of the corresponding valley.

5. The bearing unit according to claim 1, wherein both the ridges and the valleys are obtained by a 360° rotation of a geometric figure corresponding to an isosceles trapezoid.

6. The bearing unit according to claim 1, wherein both the ridges and the valleys are obtained by a 360° rotation of a geometric figure corresponding to an isosceles triangle.

7. The bearing unit according to claim 1, wherein both the ridges and the valleys of the first shaped surface are obtained by a 360° rotation of a geometric figure corresponding to an isosceles trapezoid, while both the ridges and the valleys of the second shaped surface are obtained by a 360° rotation of a geometric figure corresponding to an isosceles triangle.

8. The bearing unit according to claim 1, wherein both the ridges and the valleys of the second shaped surface are obtained by a 360° rotation of a geometric figure corresponding to an isosceles trapezoid, while both the ridges and the valleys of the first shaped surface are obtained by a 360° rotation of a geometric figure corresponding to an isosceles triangle.

9. The bearing unit according to claim 1, wherein the ridges of the first shaped surface are obtained by a 360° rotation of a geometric figure corresponding to an isosceles trapezoid, while the valleys of the first shaped surface are obtained by a 360° rotation of a geometric figure corresponding to an isosceles triangle.

10. The bearing unit according to claim 9, wherein the valleys of the second shaped surface are obtained by a 360° rotation of a geometric figure corresponding to an isosceles trapezoid, while the ridges of the second shaped surface are obtained by a 360° rotation of a geometric figure corresponding to an isosceles triangle.
